(19) United States
(12) Patent Application Publication
(10) Pub. No.: US 2015/0241211 A1
(43) Pub. Date: Aug. 27, 2015

(54) METHOD AND PROGRAM FOR ANALYZING PIPE WALL-THICKNESS VARIATIONS

(71) Applicant: Hans Joachim PEHLE, Juechen (DE)

(72) Inventor: Hans Joachim PEHLE, Juechen (DE)

(21) Appl. No.: 14/568,285

(22) Filed: Dec. 12, 2014

(30) Foreign Application Priority Data
Feb. 26, 2014 (DE) 102014203422.1

(51) Int. Cl. G01B 21/02

(52) U.S. Cl. CPC G01B 21/02

(57) ABSTRACT

A method of analyzing the wall thickness distribution of a pipe has the steps of determining the distribution of the deviation of wall thickness angularly of the pipe from a desired wall thickness distribution, and approximating the determined distribution of the wall thickness deviation through the additive overlaying of a plurality of specified distributions of the wall thickness deviation angularly. The distributions of the wall thickness deviation each represent a respective real defect type that is possible during the manufacture of the pipe, and at least one of the specified distributions represents a defect type that occurs only in an angular range of <180°.

### FIELD OF THE INVENTION

The present invention relates to a method of analyzing the variations in wall thickness of a pipe, in particular seamless pipe, during manufacture thereof. More particularly this invention concerns a program for carrying out the method.

### BACKGROUND OF THE INVENTION

Methods of analyzing the wall thickness distribution of a pipe are known in which Fourier analysis is applied to the determined wall thickness distribution; see, for example, U.S. Pat. No. 7,093,469 and U.S. Pat. No. 7,333,925. In the methods disclosed therein, the individual components of the Fourier analysis each correspond to sine functions of different frequency; however, a direct relationship to the real possible defects during the manufacture of the pipe is lacking. The interpretation and evaluation of the results of Fourier analysis with respect to specific defects during the manufacture of the pipe is therefore often difficult and yields insufficient information. This will be explained below using some examples:

One possible type of defect that can occur during the manufacture particularly of seamless pipes is a radial offsetting of a Premium Quality Finishing PQF roll in a PQF mill. This type of defect leads to an asymmetrical wall thickness deviation with specific localized occurrence. Fourier analysis determines this wall thickness deviation from sine curves of varying frequencies. In this case, Fourier analysis yields a deviation of first, second and third magnitude even though no eccentricity is present, no two-sidedness occurs in the three-roll stand as a defect, and the three-sidedness produces the incorrect indication of a symmetrical maladjustment of the rolls of the two farthest downstream PQF stands.

Finally, it should be mentioned that an approximation of the measured real wall thickness deviation distribution using a sine curve according to the Fourier analysis is regularly problematic in the case of symmetrical roll maladjustments (for example hexagonality). A remainder is then left over because the roll caliber is not circular. The remainder is symmetrical and simulates a different wall thickness deviation that does not exist in reality.

### OBJECTS OF THE INVENTION

It is therefore an object of the present invention to provide an improved method and program for analyzing pipe wall-thickness variations.

Another object is the provision of such an improved method and program for analyzing pipe wall-thickness variations that overcomes the above-given disadvantages, in particular that improves on a known method and computer program for analyzing the wall thickness distribution of a pipe in such a way that a more precise analysis of the wall thickness distributions in pipes for the presence of defects is possible during the manufacture of pipes, and defect detection is simplified.

The object of the invention is further attained by a computer program product with a computer program for executing the method according to the invention.

### SUMMARY OF THE INVENTION

A method of analyzing the wall thickness distribution of a pipe has according to the invention the steps of determining the distribution of the deviation of wall thickness angularly of the pipe from a desired wall thickness distribution, and approximating the determined distribution of the wall thickness deviation through the additive overlaying of a plurality of specified distributions of the wall thickness deviation angularly. The distributions of the wall thickness deviation each represent a respective real defect type that is possible during the manufacture of the pipe, and at least one of the specified distributions represents a defect type that occurs only in an angular range of <180°.

Through the claimed use of only such distributions of the wall thickness deviations that represent real possible defect types during the manufacture of the pipe it is possible to very quickly, easily and directly infer the presence of this respective defect type during the manufacture of the pipe if the respective specified distribution of the wall thickness deviations makes a sensible contribution to the approximation of the detected distributions of the wall thickness deviations of the pipe. The provision of the additional feature that at least one of the specified distributions represents only one defect type occurring in an angular range of <180° ensures that, using the claimed method, even those defect types can be recognized directly that cannot be detected with the use of Fourier analysis known from the prior art, because Fourier analysis normally only discovers existing defect types that extend over the entire circumference. By virtue of the latter-mentioned feature, it is advantageously also possible to discover defect types and defects that occur only locally or extend angularly limitedly.

In general, by applying the claimed method, the product quality of pipes manufactured particularly in seamless pipe systems can be substantially improved.

In this description, the term “sine function” is to be understood generally as a trigonometric function.

According to a first embodiment, the real distributions used for the approximation of the detected real distribution of the wall thickness deviations are each custom parameterized, for example through the appropriate setting of their amplitude, their frequency and/or their phasing.

The determination of the real distribution of the deviation of wall thickness angularly comprises the following substeps: Measuring the distribution of the wall thickness from the outside on the surface of the pipe or from the interior thereof and determining the difference between the measured distribution of the wall thickness and a specified desired wall thickness. The only theoretical case in which the desired wall thickness is 0 mm is intentionally also included in the present invention; in that case, the determined distribution of the deviation of wall thickness from the desired wall thickness then corresponds to the real distribution of the wall thickness. In that case, the specified distributions to be used for approximating this distribution must also refer to the wall thickness.

The specified distributions of the wall thickness deviations used for the approximation, each of which represents a different defect type, can be determined either theoretically on the basis of geometric derivations or experimentally through experiments.

### BRIEF DESCRIPTION OF THE DRAWING

The above and other objects, features, and advantages will become more readily apparent from the following description, reference being made to the accompanying drawing in which:

FIG. 1 is a cross section through a manufactured pipe with defects; and

FIGS. 2a and 2b are charts that show typical defect types with their characteristic angular distributions of wall thickness deviation.

### SPECIFIC DESCRIPTION OF THE INVENTION

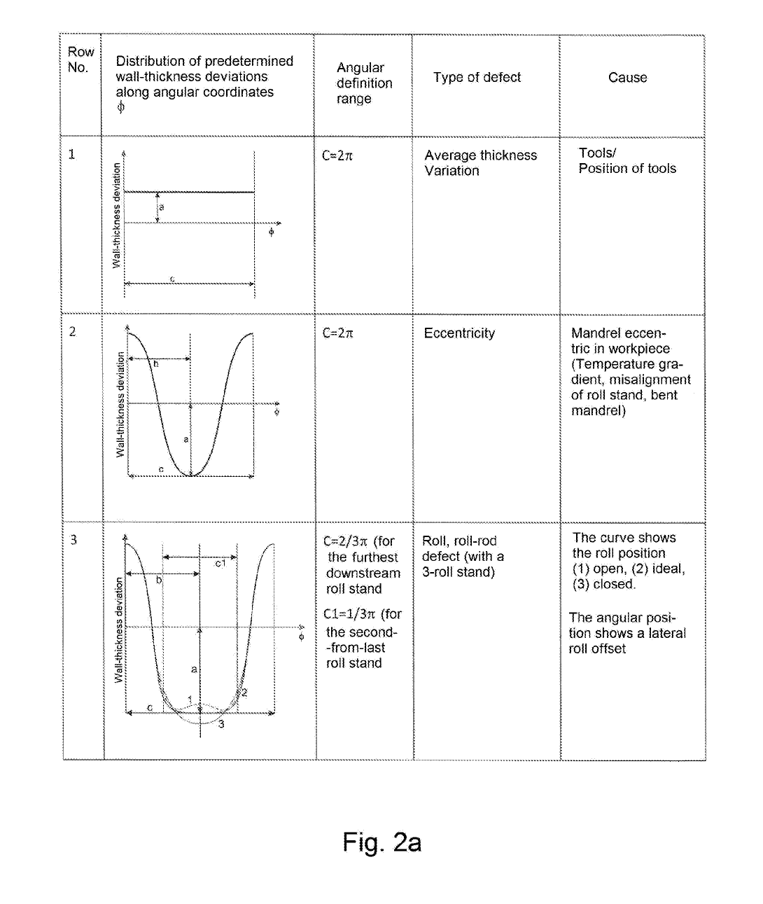

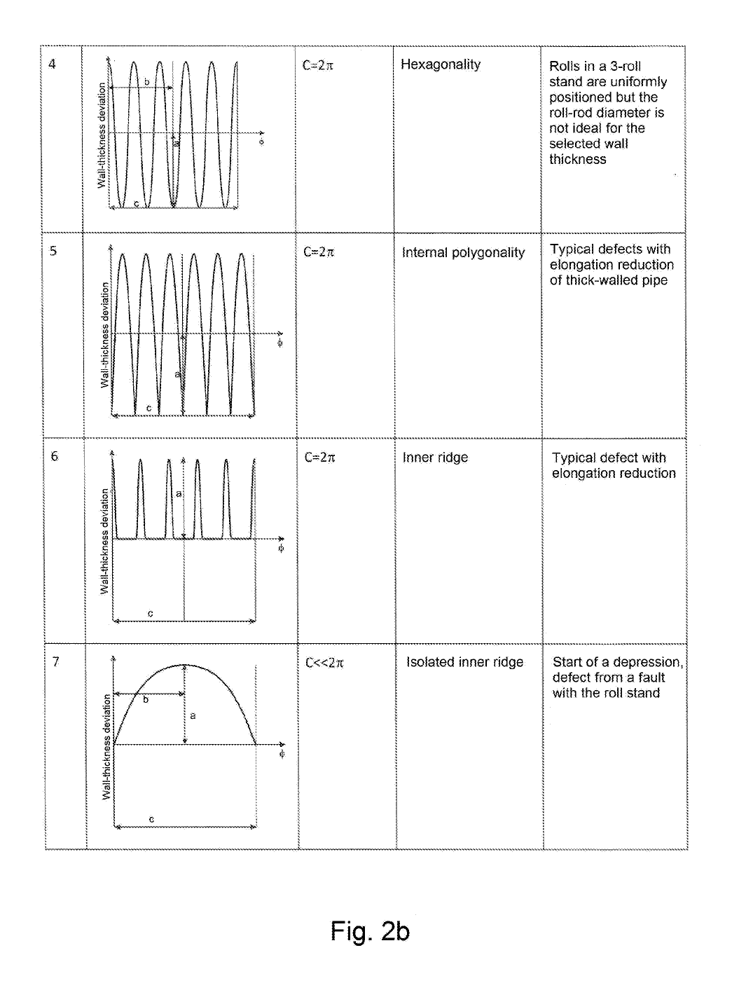

As seen in FIGS. 2a and 2b show typical defect types with their characteristic distributions of the wall thickness deviation angularly.

In FIGS. 2a and 2b:
a=amplitude
b=angular position
c=definition range.

The roll or roll rod flaws according to row 3 in FIG. 2a and the isolated defect ridge according to row 7 in FIG. 2b are defect types that each only occur in an angular range of <180°. Advantageously, the method according to the invention enables a direct inference to be made as to the defect types present during the manufacture of a pipe. These correspond to the defect types, namely through the distributions of the wall thickness deviations, that are logically used or required for the approximation of the determined and real distribution of the wall thickness deviations of the pipe to be inspected. The quick and easy identification of defect types subsequently also enables the quick determination of the causes of this defect and the quick implementation of corrective measures.

The method according to the invention for analyzing the wall thickness distribution of a pipe 10 comprises the following steps:

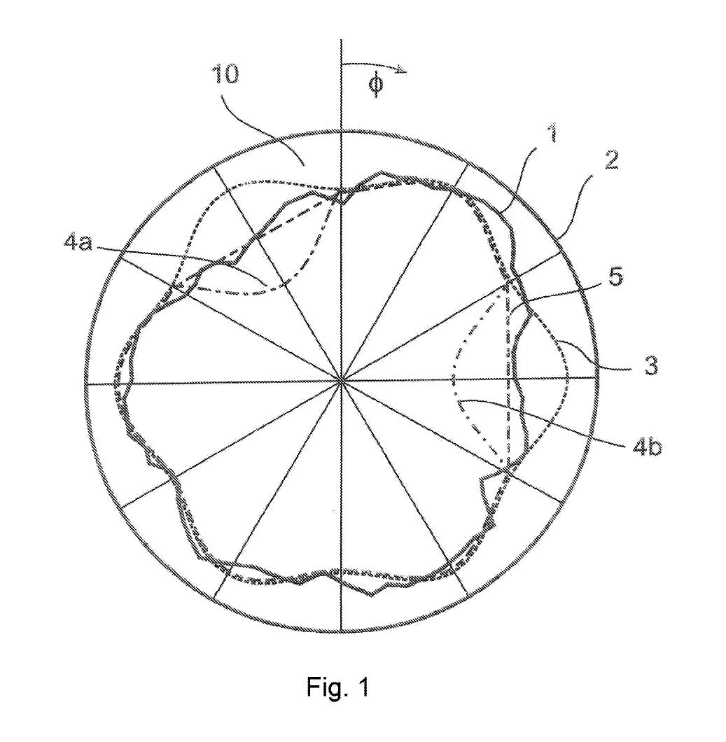

In a first step, the distribution of a deviation of wall thickness angularly F of the pipe from a specified desired wall thickness is determined. In FIG. 1, this real distribution of the wall thickness deviation is shown at 1. The desired wall thickness distribution to which the shape 1 refers is not shown in FIG. 1; in FIG. 1, it would correspond to a circle with a constant radius around the center axis of the pipe, and the radius of the circle would be smaller than the constant radius of the coaxial outer surface 2 of the pipe shown in FIG. 1.

In a second step according to the method of the invention, the determined shape 1 is approximated by a plurality of specified distributions of the wall thickness deviation, with each of these specified distributions representing different real defect types that are possible during the manufacture of the pipe. In FIG. 1, the real shape 1 is approximated by a first specified distribution of the wall thickness deviation that represents a hexagonality defect and is indicated in FIG. 1 at 3. The hexagonality defect extends over the entire circumference. Moreover, the approximation is refined by also using the distributions of the wall thickness deviations that are typical for roll flaws, each defined by π/3. These distributions are indicated in FIG. 1 at 4a and 4b. For the sake of example, they occur only at 11 o'clock and 3 o'clock in FIG. 1. Accordingly, the curve 1 is approximated by an additive overlaying of three different specified distributions that represent the abovementioned defect types of hexagonality and two phase-shifted roll flaws. The locus of the additive overlaying is indicated in FIG. 1 at 5. Everywhere along the circumference where the roll flaw defect does not occur, the locus 5 corresponds to the specified distributions for the hexagonality defect. Only in the angular regions of 11 o'clock and 3 o'clock does the locus correspond to the degree segments shown there; there, the distribution for the hexagonality defect overlaps with the roll flaw defect, which only occurs locally (in phase opposition here) according to curve segments 4a and 4b.

As a result of this analysis, a direct inference can be made as to the presence of these three above-mentioned defect types during the manufacture of the pipe shown in FIG. 1. Advantageously, immediately upon arrival at such a diagnosis, an appropriate correction can then be made to the system on which the pipe was manufactured by eliminating the causes of the cited defect types according to FIGS. 2a and 2b in a known manner.

As shown in FIGS. 1 and 2a and 2b, the distributions of the wall thickness that are typical for most defect types deviate from a pure sine function; the only one to which this does not apply is eccentricity. This is the case, however, for the roll inner-ridge or isolated inner ridge defects according to rows 3, 6 and 7 in FIGS. 2a and 2b, for example. For the roll flaw defect, the following example is cited:

A large PQF caliber of a PQF mill in seamless pipe production consists in its middle region of a circular arc that, together with a round roll rod, produces a constant wall thickness in the pipe to be manufactured. If the roll is closed, a sinusoidal profile is created, but only in the middle region. If the roll is opened, a curve is created in the middle region having one maximum and two minimums. This is shown in FIG. 2a at row 3. The edge areas of the caliber consist of degrees. Together with the roll rod, a commensurate increase in wall thickness is produced. In the regions between the rolls, a constant wall thickness is formed outside of the tool contact. Here, and possibly in the edges with a straight-line caliber profile, the roll flaw of the next-to-last stand defect is shown.

Another example: A radial offset of a PQF roll leads to an asymmetrical wall thickness deviation with specific local occurrence. During the approximation of the real distribution of the wall thickness deviation determined with this defect type, it would be found that the specified distribution of the roll-flaw defect or faulty roll adjustment is most consistent with the approximation, and that defect type would have thus been directly diagnosed.

The method according to the invention advantageously enables the diagnosis of the defect type of eccentricity.

The following applies as a matter of principle: The defect analysis made possible by the method according to the invention becomes more precise as the resolution of the measured and determined real distribution of the wall thickness deviation increases, for which reason it should be as high as possible

I claim:

1. A method of analyzing the wall thickness distribution of a pipe, the method comprising the steps of:
determining the distribution of the deviation of wall thickness angularly of the pipe from a desired wall thickness distribution; and
approximating the determined distribution of the wall thickness deviation through the additive overlaying of a plurality of specified distributions of the wall thickness deviation angularly, the distributions of the wall thickness deviation each representing a respective different real defect types that is possible during the manufacture of the pipe, at least one of the specified distributions representing a defect type that occurs only in an angular range of <180°.

2. The method defined in claim 1, wherein the step of approximating includes the step of appropriately paramaterizing each of the specified distributions of the wall thickness deviations.

3. The method defined in claim 2, wherein the specified distributions of the wall thickness deviations are parameterized with respect to amplitude, frequency or phase.

4. The method defined in claim 1, wherein the step of determining the wall thickness deviations includes the following steps:
measuring the distribution of the wall thickness from the outside on the surface of the pipe or from the interior of the pipe; and
determining the difference between the measured distribution of the wall thickness and a desired wall thickness.

5. The method defined in claim 1, wherein the specified distributions of the wall thickness deviations each represent a respective different defect type and are determined theoretically on the basis of geometric derivation or experimentally.

6. The method defined in claim 1, wherein the different defect types are deviations include mean wall thickness, different eccentricities, roll or roll rod roll flaws, multi-sidedness, internal polygonality, and inner ridges.

7. The method defined in claim 6, wherein the defect types of roll or roll rod roll flaws and inner ridge each occur only in an angular range of <180°.

8. The method defined in claim 1, wherein the method immediately follows a continuous pipe-manufacturing process, the method further comprising the steps of:
determining for each of the wall-thickness deviations a cause in the manufacturing process; and
addressing the cause and eliminating the respective defect.

9. A computer program product with a computer program for running on a microprocessor, the computer program being designed for executing the method defined in claim 1.
